(19) United States
(12) Patent Application Publication
(10) Pub. No.: US 2008/0314196 A1
(43) Pub. Date: Dec. 25, 2008

(54) Universal Light Transmission

(76) Inventors: Toshihiro Fukumoto, Tokyo (JP); Keiko Ebato, Tokyo (JP)

Correspondence Address: BROWDY AND NEIMARK, P.L.L.C.;624 NINTH STREET, NW, SUITE 300, WASHINGTON, DC, 20001-5303, US

(21) Appl. No.: 10/578,467

(22) PCT Filed: Nov. 12, 2003
(86) PCT No.: PCT/JP03/14396

§ 371 Date: Aug. 25, 2008

(51) Int. Cl. F16H 3/02

(52) U.S. Cl. 74/745

(57) ABSTRACT

A light and small-sized gear type multi-stage automatic transmission capable of eliminating the power loss in comparison with a current automatic transmission and usable also for a large-sized vehicle by diversifying gears, wherein backward position, and a neutral position and several gear blocks for changing the shift between HIGH and LOW are combined to operate the transmission with the microcomputer operation. Since the gear for changing the shift between HIGH and LOW can provide the number of speed change by the number of grade of the number of the gears to be combined, the gear for changing the shift between HIGH and LOW can improve the fuel consumption and can cope with an engine brake by utilizing the combination of an electronic parking brake with the selection of the gear. In addition, since the same gear block is used, the manufacturing cost is remarkably reduced.

### TECHNICAL FIELD

The present invention relates to a structure of leaving out a clutch which occupies big specific gravity among weight of a vehicle, realizing significant lightening and a manufacturing cost cut of a transmission, and a structure of the parking brake which operates certainly at the time of necessity.

### BACKGROUND ART

As structure of an automatic transmission, a starting device which used the torque converter is put in practical use conventionally, and the actuator which used the belt made from steel is put in practical use recently. However, it is difficult to use above all to the engine of large displacement volume, and there is much loss of energy in above structures.

The present invention has been made to provide a structure of weight saving of a transmission which occupies big weight among vehicles, lightening of a vehicle by leaving out a clutch, realizing of the smooth operation characteristic more than a torque converter, and changing the number of speed change and fluctuating a load rigidity coefficient by the change in the use number of a gear block of the same structure to let torque loads from a compact car to a full-size vehicle support, and to reduce a manufacturing cost.

### DISCLOSURE OF THE INVENTION

Several light and small-sized gear block for changing the shift between HIGH and LOW (It is hereafter called (1)) are combined, slow down an engine rotation speed, and transmit power to a power ring. In this case it is decided how many (1) are combined by relations of torque of an engine and greatest vehicle weight. Moreover, it is decided also in order to smooth the acceleration and slowdown at the time of a run.

As for the last slowdown ratio, it is slowed down by the number of grade of the combination number of (1), a designer should just combine the number of blocks of (1) so that the last slowdown ratio to mean may be reached.

A gear block for changing the shift to a forward position, a backward position, and a neutral position (It is hereafter called (2)) is used. The structure of (2) operates the state of a forward position and a neutral position by inserting in the gear structure of the 2nd gear and the 4th gear at a forward position and operating slide gear (It is hereafter called (3)) which retreat and race at a neutral position.

A transmission is constituted by combining several (1) with one set for (2). In this case, since the rigidity over engine torque can be maintained with the whole transmission, large lightening is realizable.

Moreover, by the change in the number of (1), the rigidity of the whole transmission is adjusted and change of the number of speed change is realizable. Therefore, as long as there is no much difference in a vehicle gross weight, it is possible to correspond only by the change in the number of (1). Operation of a gear is controlled with a microcomputer, and it is performed by oil pressure or power depended electric.

Since a neutral position is automatically realizable by using (3), it is possible to delete a clutch.

In the case that a transmission is in a neutral position by use of (3), when a sensor senses that gear after (1) is not rotating, a parking brake is operated by oil pressure or solenoid by control with a microcomputer.

When a sensor senses the number of the rotation of an engine, speed of a vehicle, the degree of progress of an accelerator, and quantity of outbreak torque, a transmission operates automatically by control with a microcomputer in the mode which the designer set up. However, the operation mode (for example, the high-speed mode, the usual mode, the mountain path mode, the muddy road mode, the snow mode, and the back mode) in which a driver's intention was made to reflect can also be set up.

According to each operation mode, the change the shift between HIGH and LOW of (1) is set up. Moreover, in the mountain path mode, the muddy road mode, and the snow mode, the program is set so that the engine brake senses an accelerator angle, the number of the rotation of an engine, and speed.

As a form of invention enforcement, a above block group is installed in a vehicle as a substitute of a clutch and a former type transmission.

### BRIEF DESCRIPTION OF THE DRAWINGS

FIG. 1 shows the use form of a gear box (44) for changing the shift between HIGH and LOW shown in FIG. 4 in the whole transmission.

FIG. 2 shows the use form of a gear box (35) for changing the shift to a forward position, a backward position, and a neutral position shown in FIG. 4 in the whole transmission.

FIG. 3 is a conceptual figure of an oil pressure control system for a change of gear, an oil reservoir system, and a pressurization pump oil tank.

FIG. 4 shows the state where the gear boxes are connected. (19) shows a brake.

FIG. 5 shows the conceptual figure of a brake.

FIG. 6 shows the internal concept figure of the brake cylinder which operates a brake.

### EXPLANATION OF SYMBOLS

1: Male type joint
2: Bearing
3: Oil seal
4: Front part main gear
5: Main gear
6: Rear main gear
7: 1st gear
8: 2nd gear
9: 3rd gear
10: 4th gear
11: Female type joint
12: Slide gear slide ditch
13: Slide gear movement power device
14: Slide gear movement arm
15: Oil pipe
16: Oil controller
17: Pipe
18: Cylinder
19: Drum
20: Controller and a sensor detecting a rotation of an engine
21: Shaft
22: Brake lining
23: Brake shoe
24: Brake shoe linkage
25: Slide gear
26: Change gear movement power device
27: Return oil pipe
28: Oil reserve tank
29: High-pressure oil tank
30: Oil pump
31: Oil pressure sensor
32: Gear movement controller
33: Electric wire for signals
34: Electromagnetic valve
35: Gear block for changing the shift to a forward position,
a backward position, and a neutral position
36: Solenoid controller
37: Solenoid
38: Oil pressure equipment
39: Pressure shaft
40: Return spring
41: Oil cylinder
42: Ring stick
43: Upper part gear structure
44: Gear box for changing the shift between HIGH and LOW

### BEST MODE FOR CARRYING OUT THE INVENTION

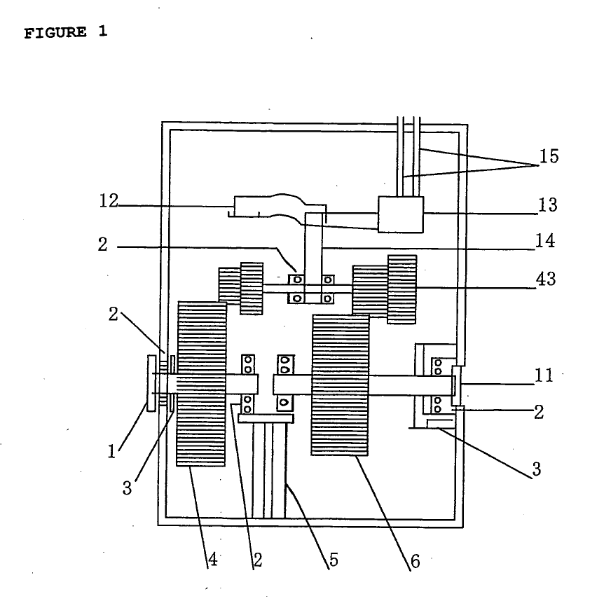

FIG. 1 shows the sections which perform the operation of a transmission in variable speed with two steps of structures between HIGH and LOW. Two combinations of large gear and small gear in superstructure (the combination of HIGH and the combination of LOW) moves along a ditch by using arm by oil pressure or electricity according to the microcomputer control, and switches the number of speed change. The substructure consists of two different size of gears independently, and transmits the rotation obtained by front joint to rear gear through upside gear from front part gear. It also makes the number of the rotation of a gear a different state, and transmits the rotation to the following structure from rear joint.

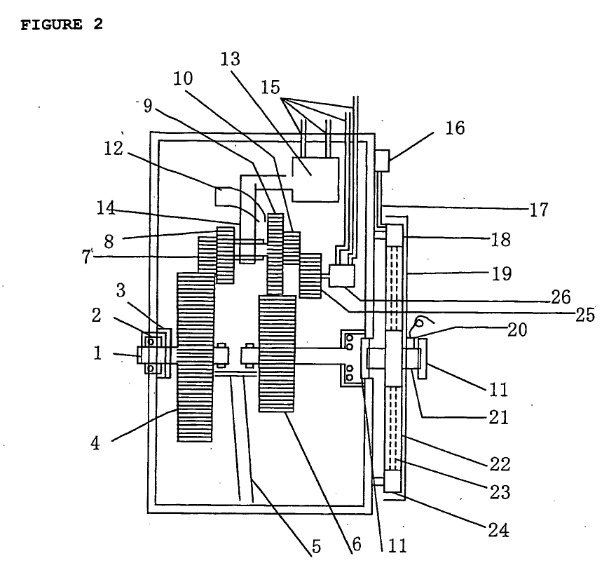

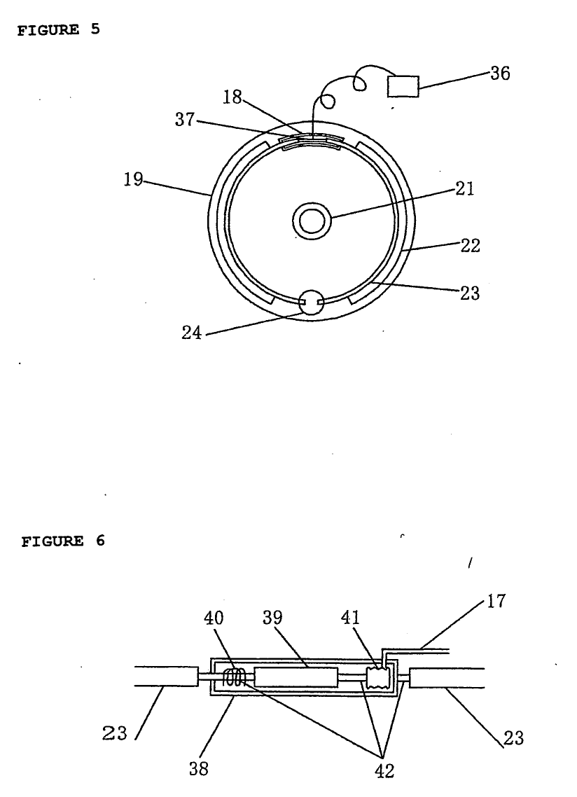

Although FIG. 2 is fundamentally the same as the structure of FIG. 1, FIG. 2 shows the structure which changes the shift to a forward position while slide gear is operating whole of superstructure or only the rear of superstructure, and changes the shift to a neutral position while slide gear is not operating. Moreover, FIG. 2 shows the structure which changes the shift to a backward position, while the group of the 3rd gear and the 1st gear of superstructure is operating. The structure of a brake drum is shown by FIG. 5 and FIG. 6. In addition, FIG. 5 and FIG. 6 are conceptual figures which show control by oil pressure equipment.

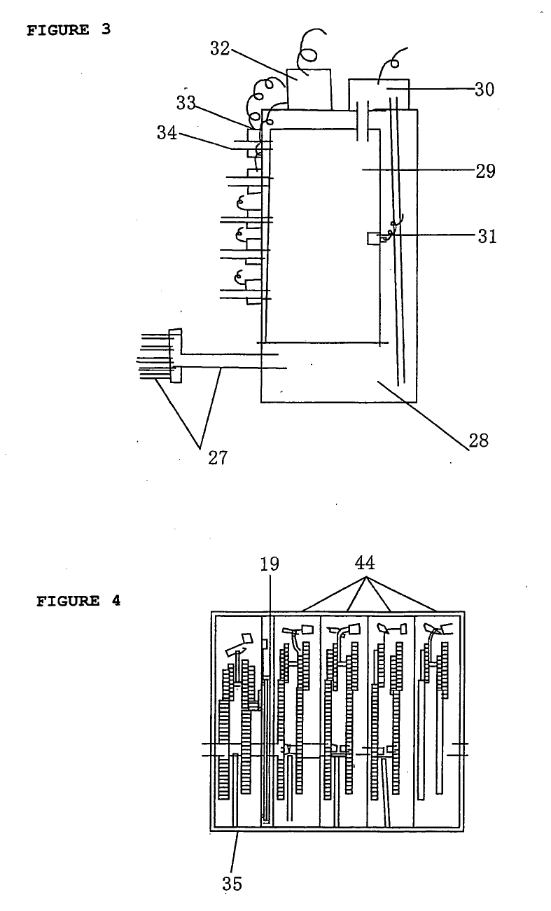

FIG. 3 shows the conceptual figure of oil storage tank and piping in the case of sliding the gear group of superstructure by power by oil pressure.

FIG. 4 shows the conceptual figure in the state where one (2) is combined with several sets for (1).

FIG. 5 shows the structure in a brake drum. Moreover, FIG. 5 is a conceptual figure which shows the detection structure of a senses a rotation sensor and the situation of (2), adjusts the power to a pressure shaft by means of electromagnetic power generated by operation of the solenoid switch or oil pressure by oil pressure control with a microcomputer, and thereby operates an supplementary brake shoe, and operates an supplementary braking system by friction of a brake drum and brake lining.

FIG. 6 is a conceptual figure in the oil pressure equipment in case of control by oil pressure in FIG. 5.

### AVAILABILITY ON INDUSTRY

This invention can be broadly used as a transmission of equipment which needs a smooth action in variable speed of a vehicle, an industrial work vehicle, the industrial apparatus, the work vehicle for agriculture, etc.

1. Structure to combine several transmissions formed of a block having a slowdown ratio of two steps or three steps and to work a role of a transmission of a vehicle.

2. Structure to combine single transmission formed of block and single gear block which changes the shift to a forward position, a backward position, and a neutral position in order to establish the alternative function of a clutch.

3. Structure of a transmission which runs a vehicle at stable speed and has the number of the most suitable rotations of an engine by operating the gear of the whole block for one structure with electronic control to obtain the final gear ratio.

4. Structure according to claim 2, wherein the gear block which changes the shift to a forward position, a backward position, and a neutral position combined with a electronically controlled parking brake so as to leave out a clutch.

5. Structure to unify a gear box and an supplementary brake in order to obtain the stable operation of a supplementary brake regardless of the main brake by unifying.
